(19) United States
(12) Patent Application Publication
(10) Pub. No.: US 2025/0012928 A1
(43) Pub. Date: Jan. 9, 2025

(54) SYSTEMS AND METHODS FOR VERIFYING NAVIGATION SIGNALS

(71) Applicant: Indian Institute of Technology Delhi, New Delhi (IN)

(72) Inventors: Brejesh Lall, New Delhi (IN); Sk Subidh Ali, Raipur (IN); Debanka Giri, New Delhi (IN); Sudev Kumar Padhi, Raipur (IN)

(73) Assignee: Indian Institute of Technology Delhi, New Delhi (IN)

(21) Appl. No.: 18/520,583

(22) Filed: Nov. 28, 2023

(30) Foreign Application Priority Data
Jul. 5, 2023 (IN) IN 202311045094

(51) Int. Cl. G01S 19/21; G01S 19/37

(52) U.S. Cl. CPC G01S 19/215; G01S 19/37

(57) ABSTRACT

Embodiments disclosed herein relate to monitoring navigation signals, and more particularly to verifying navigation signals, which can comprise of detecting spoofing and glitches in navigation signals by analyzing sequential time series data in the navigation signal. embodiments herein is to disclose methods and systems for verifying navigation signals, wherein navigation signals received by a receiver is timestamped, using a sequential model (such as, but not limited to, Long Short-Term Memory (LSTM), Recurrent Neural Network (RNN), and so on) for verifying patterns in the timestamped time series navigational signals, and determining whether the navigation signal is spoofed using the verified/unverified patterns.

### CROSS REFERENCE TO RELATED APPLICATIONS

This application is based on and derives the benefit of Indian Application 202311045094 filed on 5 Jul. 2023, the contents of which are incorporated herein by reference.

### TECHNICAL FIELD

Embodiments disclosed herein relate to monitoring navigation signals, and more particularly to verifying navigation signals, which can comprise of detecting spoofing and glitches in navigation signals by analyzing sequential time series data in the navigation signal.

### BACKGROUND

Currently, for performing their respective tasks, various systems using geo-location means (such as Global Positioning Systems (GPS), Global Navigation Satellite System (GLONASS), Galileo, Indian Regional Navigation Satellite System (IRNSS), Navigation with Indian Constellation (NavIC), and so on) as a primary and essential navigational aid for localization information, including veracity, position, and timing. Examples of the applications can be, but not limited to, an Unmanned Aerial Vehicle (UAV) relying on navigation signals for navigation and movement, a user using a navigation application (such as Google Maps, Waze, Apple Maps, and so on), an autonomous vehicle navigating roads, emergency services, and so on.

Spoofing attacks are a very important issue in the navigation domain. In a spoofing attack, the attacker transmits a spoofed signal such a way that the receiver calculates a false location based on the received signal (as depicted in the example in FIGS. 1A and 1B). The main theme of the spoofing technique is that the attacker transmits counterfeit signals which are identical to the original signals. Navigation systems are a simplex system, where there are no security measures (such as handshake/authentication) available. Attackers can use it as a backdoor to generate spoofed signals in different ways like by modifying the content of the navigation message, modifying time of arrival etc.

In an example, since a GPS satellite works far away from the earth, a signal at a receiver on the earth can be very poor and can be easily affected by deliberate interference. An attacker can easily generate the spoofed signal redirecting a UAV to an unexpected destination. It has been shown by researchers that GPS spoofing attacks can be a threat to human life, emergency services, and the safety of other critical services or infrastructure.

Generally, non-machine learning based spoofing detection methods (such as signal quality monitoring methods, signal power measuring methods, arrival of time measurement methods, and so on) require hardware modifications or installation of extra hardware like an additional antenna. As a result, commercial systems face several difficulties in adopting these mechanisms.

Therefore, researchers focus on Machine Learning (ML) based solutions that solve the previous drawbacks by analyzing the data to find the spoofed signal. Multiple ML-based detection methods have been proposed. While simple ML models and Deep Neural Network (DNN)-based models can be used to identify spoofed signals, the major issue faced in using these models is that they do not capture the dependency of the signals for different time steps.

### OBJECTS

The principal object of embodiments herein is to disclose methods and systems for verifying navigation signals, wherein navigation signals received by a receiver is timestamped, using a sequential model (such as, but not limited to, Long Short-Term Memory (LSTM), Recurrent Neural Network (RNN), and so on) for verifying patterns in the timestamped time series navigational signals, and determining whether the navigation signal is spoofed using the verified/unverified patterns.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the drawings, in which:

FIGS. 1A and 1B depict an example scenario, wherein a receiver calculates its geo-location wrongly due to a spoofed signal, according to prior arts;

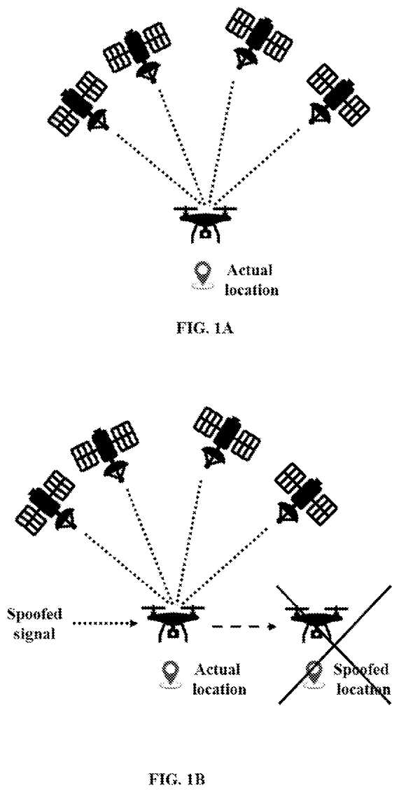

FIG. 2 depicts a system for detecting spoofing of navigation signals, according to embodiments as disclosed herein;

FIG. 3 is a flowchart depicting the process of verifying a received navigation signal (i.e., whether a received navigation signal is a spoofed signal or a genuine signal), according to embodiments as disclosed herein:

FIG. 4 depicts a receiver, wherein the receiver is configured to detect whether a received navigation signal is a spoofed signal or a genuine signal, according to embodiments as disclosed herein;

FIG. 5 depicts an example scenario, wherein a LSTM is used for determining whether a received GPS signal is spoofed or not, according to embodiments as disclosed herein; and

FIG. 6 depicts the process of training the neural network, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

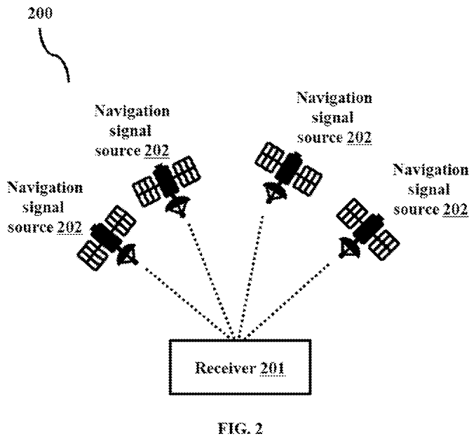

The embodiments herein achieve methods and systems for detecting spoofing and glitches in navigation signals. Referring now to the drawings, and more particularly to FIGS. 2 through 6, where similar reference characters denote corresponding features consistently throughout the figures, there are shown embodiments.

Embodiments herein disclose methods and systems for detecting spoofing and glitches in navigation signals, wherein navigation signals received by a receiver is timestamped, using a sequential model (such as, but not limited to, Long Short-Term Memory (LSTM), Recurrent Neural Network (RNN), and so on) for verifying patterns in the timestamped time series navigational signals, and determining whether the navigation signal is spoofed using the verified/unverified patterns in time series signal data. The sequential models can be used to learn, process, and classify sequential data because these models can learn long-term dependencies between time steps of data. The navigation signal received by the receiver can be in the form of continuous data. Hence, the sequential models are successful in capturing the dependency and finding the unique patterns that are able to differentiate the spoofed signals and the genuine signals.

FIG. 2 depicts a system for detecting spoofing of navigation signals. Navigation systems, as disclosed herein, can be any signal that can be used for navigation. Examples of the navigation systems can be, but not limited to, Global Positioning Systems (GPS), Global Navigation Satellite System (GLONASS), Galileo, Indian Regional Navigation Satellite System (IRNSS), Navigation with Indian Constellation (NavIC), and so on

The system 200, as depicted, comprises one or more receivers 201, and one or more navigation signal sources 202. The one or more navigation signal sources 202 can be one or more satellites in orbit around the earth, wherein the one or more navigation signal sources 202 can broadcast one or more navigational signals. The broadcasted signals can be received by one or more receivers 201. The receiver 201 can be any device that is capable of receiving navigation signals and performing navigation directly using the received signal or providing the signals to another device for performing navigation. In an embodiment herein, the receiver 201 can be a dedicated device, wherein the device can perform only navigation: such as, but not limited to, a portable navigation device, a navigation device in a vehicle (such as Tomtom, Mapmyindia, and so on), and so on. In an embodiment herein, the receiver 201 can be a device that may be present in another device/equipment/vehicle, wherein examples of the device/equipment/vehicle can be, but not limited to, a vehicle (such as in an instrument cluster, an infotainment system, a heads up display, and so on), an Unmanned Aerial Vehicle (UAV), a ship, a boat, a mobile phone, a smart phone, a tablet, a computer, and so on.

The receiver 201, on receiving a navigation signal, can pre-process the received navigation signal. Pre-processing the received navigation signal can comprise of normalizing and standardizing data values of the received navigation signal, such that the data values can be in a predefined range with minimal deviation. The data values can be a plurality of features of the received navigation signal. Consider that the navigation signal is a GPS signal, then the examples of the features can be, but not limited to, abs_E, abs_L, abs_P, abs_VE, abs_VL, acc_carrier_phase_rad, aux1, aux2, carr_error_filt_hz, carr_error_hz, carrier_doppler_hz, carrier_doppler_rate_hz, carrier_lock_test, CN0_SNV_dB_Hz, code_error_chips, code_error_filt_chips, code_freq_chips, code_freq_rate_chips, CT_LOCK, CT_LOSS, E_I, E_R, L_I, L_R, PRN, PRN_start_sample_count, Prompt_I, Prompt_Q, TG_LOCK, TS_corr, TS_LOCK, TS_LOSS, and TS_TRK. The receiver 201 can use a time series based neural network (such as, but not limited to, LSTM, RNN) to check if the pre-processed data is a genuine navigation signal or a spoofed navigation signal by mapping impact of each of the plurality of features. In an embodiment herein, the receiver 201 can raise an alert, on determining that the received navigation signal is a spoofed signal. In an embodiment herein, the receiver 201 can ignore the received navigation signal, on determining that the received navigation signal is a spoofed signal.

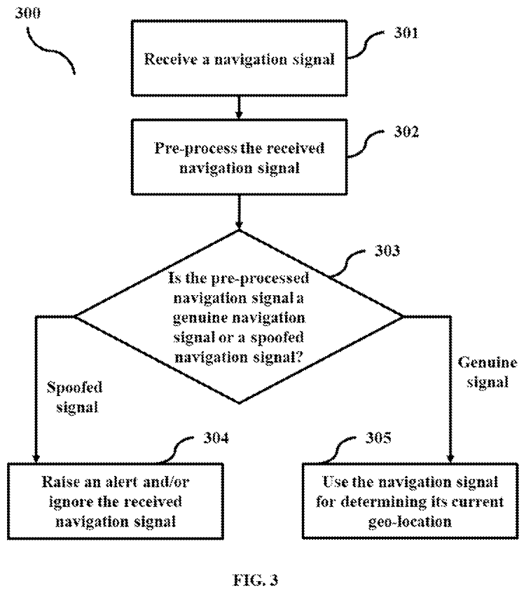

FIG. 3 is a flowchart depicting the process of verifying a received navigation signal (i.e., whether a received navigation signal is a spoofed signal or a genuine signal). In step 301, the receiver 201 receives a navigation signal. In step 302, the receiver 201 pre-processes the received navigation signal, which can comprise of normalizing and standardizing data values of the received navigation signal (i.e., the plurality of features of the received navigation signal), such that the data values are in a pre-defined range with minimal deviation, and configuring the normalized and standardized navigation signal into a plurality of channels, wherein each feature can correspond to a channel. In step 303, the receiver 201 checks if the pre-processed navigation signal is a genuine navigation signal or a spoofed navigation signal using the time series based neural network (such as, but not limited to, LSTM, RNN). If the navigation signal is a spoofed signal, in step 304, the receiver 201 raises an alert and/or ignores the received navigation signal. If the navigation signal is a genuine signal, in step 305, the receiver 201 uses the navigation signal for determining its current geo-location. The various actions in method 300 may be performed in the order presented, in a different order or simultaneously. Further, in some embodiments, some actions listed in FIG. 3 may be omitted.

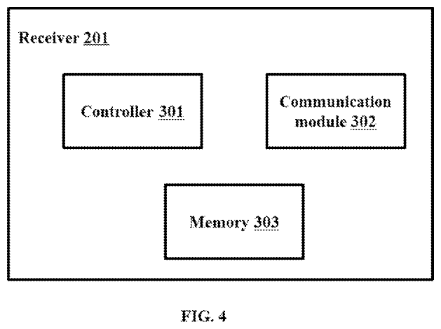

FIG. 4 depicts a receiver, wherein the receiver is configured to detect whether a received navigation signal is a spoofed signal or a genuine signal. In an embodiment herein, the receiver 201 can be a navigation module (such as, but not limited to, a GPS module), an earth station, a Software Defined Radio (SDR), or any other module that can determine the current location of the receiver 201 using navigation signals. The receiver 201 can comprise a controller 401, a communication module 402, and a memory 403.

The communication module 402 can enable the receiver 201 to send/receive signals. In an embodiment herein, the communication module 402 can enable the receiver 201 to receive navigation signals. In an example herein, the communication module 402 can enable the receiver 201 to receive GPS signals. The communication module 402 can further enable the receiver 201 to communicate with one or more external entities, such as a mobile phone, a vehicle (such as a car, a truck, a bus, a train, an UAV, and so on) using at least one of a wired means or a wireless means. Examples of the wired means can be a printed circuit, a communication cable, and so on. Examples of the wireless means can be, but not limited to, Bluetooth, Wi-Fi direct, Wi-Fi, Bluetooth Low Energy (BLE), and so on. The communication module 402 can further enable the receiver 201 to communicate with an external entity, such as, a speaker, a display, one or more lights, and so on, using at least one of a wired means or a wireless means. Examples of the wired means can be a printed circuit, a communication cable, and so on. Examples of the wireless means can be, but not limited to, Bluetooth, Wi-Fi direct, Wi-Fi, Bluetooth Low Energy (BLE), and so on.

The memory 403 stores at least one of, the trained model, results of previous checking of navigation signals (if they are genuine/spoofed signals), determined geolocation of the receiver 201, and so on. Examples of the memory 403 may be, but are not limited to, NAND, embedded Multimedia Card (eMMC), Secure Digital (SD) cards, Universal Serial Bus (USB), Serial Advanced Technology Attachment (SATA), solid-state drive (SSD), and so on. Further, the memory 403 may include one or more computer-readable storage media. The memory 403 may include one or more non-volatile storage elements. Examples of such non-volatile storage elements may include Random Access Memory (RAM), Read Only Memory (ROM), magnetic hard discs, optical discs, floppy discs, flash memories, or forms of electrically programmable memories (EPROM) or electrically erasable and programmable (EEPROM) memories. In addition, the memory 403 may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that may, over time, change (e.g., in Random Access Memory (RAM) or cache).

The controller 401 can detect whether a received navigation signal is a spoofed signal or a genuine signal. The term ‘controller 401’ as used in the present disclosure, may refer to, for example, hardware including logic circuits: a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. For example, the controller 401 may include at least one of, a single processer, a plurality of processors, multiple homogeneous or heterogeneous cores, multiple Central Processing Units (CPUs) of different kinds, microcontrollers, special media, and other accelerators.

The communication module 402 can receive a navigation signal from a source, wherein the source can be one or more satellites, a spoofing device, and so on. The communication module 402 can provide the received navigation signal to the controller 401.

On receiving the navigation signal, the controller 401 can pre-process the navigation signal. The controller 401 can perform pre-processing by normalizing and standardizing the data values of the received navigation signal, such that the data values can be in a pre-defined range with minimal deviation. In an embodiment herein, the received navigation signal can be time series data. The data values can be a plurality of features of the received navigation signal. Consider that the navigation signal is a GPS signal, then the examples of the features can be, but not limited to, abs_E, abs_L, abs_P, abs_VE, abs_VL, acc_carrier_phase_rad, aux1, aux2, carr_error_filt_hz, carr_error_hz, carrier_doppler_hz, carrier_doppler_rate_hz, carrier_lock_test, CN0_SNV_dB_Hz, code_error_chips, code_error_filt_chips, code_freq_chips, code_freq_rate_chips, CT_LOCK, CT_LOSS, E_I, E_R, L_I, L_R, PRN, PRN_start_sample_count, Prompt_I, Prompt_Q, TG_LOCK, TS_corr, TS_LOCK, TS_LOSS, and TS_TRK. The controller 401 can configure the pre-processed navigation signal into a plurality of channels, wherein each feature can correspond to a channel. In an example, if there are 33 features of the navigation signal which are to be analyzed, the controller 401 can configure the pre-processed navigation signal into 33 channels.

The controller 401 can use the time series based neural network to check if the navigation signal is a genuine navigation signal or a spoofed navigation signal. The time series based neural network can convert the normalized features (from the pre-processed navigation signal) to a meaningful vector, wherein each of the plurality of features are converted to a vector, hereby enabling each input feature to be utilized to the maximum extent.

The time series based neural network can compare patterns in the time series data of the features of the received navigation signal with patterns of the respective features of the time series data of previously recorded navigation signals, wherein the time series based neural network has been trained using the previously recorded navigation signals, which have been recorded at a plurality of locations.

If the controller 401 determines that the received navigation signal is a genuine signal, the controller 401 can then use the received navigation signal for determining the current geo-location of the receiver 201.

If the controller 401 determines that the received navigation signal is a spoofed signal, the controller 401 can discard the received navigation signal (i.e., the receiver 201 does not use the received navigation signal for determining the current geo-location of the receiver 201). The controller 401 can further raise an alert to a user of the receiver 201, using the communication module 402. The alert can be in the form of at least one of a pop-up notification, an audio alert, a light or sequence of lights, and so on.

In an example, if the receiver 201 is in a UAV, the controller 401 can provide an alert to an operator of the UAV on a control console of the UAV. In an example, if the receiver 201 is in a mobile phone, the controller 401 can provide an alert to a user of the mobile phone using a pop-up notification on the mobile phone.

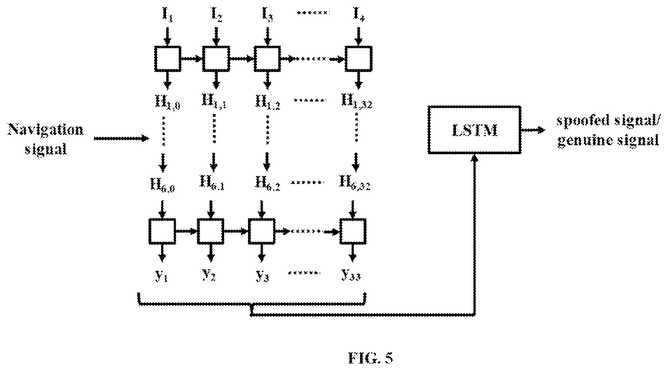

FIG. 5 depicts an example scenario, wherein a LSTM is used for determining whether a received GPS signal is spoofed or not. In the depicted example, consider that the received navigation signal is a GPS signal. On receiving the GPS signal, the receiver 201 can pre-process the navigation signal (which can be time series data) by normalizing and standardizing the data values of the received navigation signal, such that the data values can be in a pre-defined range with minimal deviation. The receiver 201 can use the following 33 features of the GPS signal: abs_E, abs_L, abs_P, abs_VE, abs_VL, acc_carrier_phase_rad, aux1, aux2, carr_error_filt_hz, carr_error_hz, carrier_doppler_hz, carrier_doppler_rate_hz, carrier_lock_test, CN0_SNV_dB_Hz, code_error_chips, code_error_filt_chips, code_freq_chips, code_freq_rate_chips, CT_LOCK, CT_LOSS, E_I, E_R, L_I, L_R, PRN, PRN_start_sample_count, Prompt_I, Prompt_Q, TG_LOCK, TS_corr, TS_LOCK, TS_LOSS, and TS_TRK. The receiver 201 can configure the pre-processed navigation signal into 33 channels, which is provided to the trained LSTM model, to determine whether the received GPS signal is a spoofed signal or a genuine signal, based on a comparison of the patterns in the received GPS signal and training data.

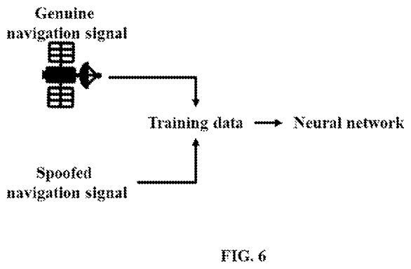

FIG. 6 depicts the process of training the neural network. To train the machine learning model, embodiments herein collect both genuine and spoofed navigation signals at various locations as training data. To enable the neural network to identify all possible types of spoofed navigation signals, the spoofed data can be generated in multiple ways. In an example herein, a first method involves capturing navigation signals and replays the captured navigation signals again, after some time with a higher signal strength which forces the receiver to capture the spoofed signal leading to the wrong location. In an example herein, a second method uses software to manipulate captured navigation signals and then transmit the manipulated signals with a higher signal strength forcing the receiver to fail. In an example herein, a third method involves creating its own navigation signal with higher signal strength, thereby fooling the receiver. The training data is provided to the neural network, wherein the network is trained till the loss becomes small and the accuracy is high enough. The network is trained in a manner such that the signal can be monitored in a continuous manner.

When LSTM (based on time series data) is used, embodiments herein extract features from the currently captured signal based on current input(s) and previous input(s) of the time series data of GPS. Based on the extracted features, embodiments herein can classify the current instance if the signal is fake or real. In an example scenario, consider that a fake signal (i.e., an interference signal) is received, embodiments herein can determine that the received signal is a fake signal (by comparing the extracted features of the fake signal with the extracted features of previously received signals) and discard the received fake signal.

Embodiments here in tackle the issue of spoofing navigation signals by analyzing the features extracted from the signal received by the receiver continuously as a form of sequential data (time series data). Embodiments herein are compatible and adaptable with a plurality of systems and devices. Embodiments herein provide a cost-effective method to determine a counterfeit navigation signal with spoofing detection. Embodiments herein disclose a method to determine a counterfeit navigation signal with spoofing detection thereof, which is very convenient in terms of use.

Embodiments disclosed herein can be commercialized as an anti-spoofing solution for various industries/systems that heavily rely on GPS for positioning, such as, but not limited to, autonomous vehicles, maritime vessels, logistics, transportation networks, and so on. By offering robust protection against spoofing attacks, embodiments herein ensure the integrity and reliability of location-based services.

The embodiments disclosed herein can be implemented through at least one software program running on at least one hardware device and performing network management functions to control the network elements. The network elements include blocks which can be at least one of a hardware device, or a combination of hardware device and software module.

The embodiment disclosed herein describes methods and systems for detecting spoofing and glitches in navigation signals. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the spirit and scope of the embodiments as described herein.

We claim:

1. A method (300) for verifying a received navigation signal, the method comprising:
pre-processing (302), by a receiver (101), a received navigation signal; and
verifying (303), by the receiver (101), if the pre-processed navigation signal is a genuine navigation signal or a spoofed navigation signal by verifying patterns in the pre-processed navigation signal using a trained time series neural network.

2. The method, as claimed in claim 1, wherein pre-processing the received navigation signal comprises:
normalizing and standardizing, by the receiver (101), a plurality of features of the received navigation signal, such that values of the plurality of features are in a pre-defined range with minimal deviation; and
configuring, by the receiver (101), the normalized and standardized navigation signal into a plurality of channels.

3. The method, as claimed in claim 2, wherein the plurality of features comprise abs_E, abs_L, abs_P, abs_VE, abs_VL, acc_carrier_phase_rad, aux1, aux2, carr_error_filt_hz, carr_error_hz, carrier_doppler_hz, carrier_doppler_rate_hz, carrier_lock_test, CN0_SNV_dB_Hz, code_error_chips, code_error_filt_chips, code_freq_chips, code_freq_rate_chips, CT_LOCK, CT_LOSS, E_I, E_R, L_I, L_R, PRN, PRN_start_sample_count, Prompt_I, Prompt_Q, TG_LOCK, TS_corr, TS_LOCK, TS_LOSS, and TS_TRK.

4. The method, as claimed in claim 3, wherein verifying patterns in the pre-processed navigation signal comprises comparing patterns in the plurality of features in the pre-processed navigation signal with patterns in corresponding features of previously recorded navigation signals, wherein the time series based neural network has been trained using the previously recorded navigation signals recorded at a plurality of locations.

5. The method, as claimed in claim 1, wherein the time series neural network is at least one of a Long Short-Term Memory (LSTM); and a Recurrent Neural Network (RNN).

6. The method, as claimed in claim 1, wherein on determining that the received navigation signal is spoofed, the method further comprises at least one of:
raising an alert, by the receiver (101); and
ignoring the received navigation signal, by the receiver (101).

7. The method, as claimed in claim 1, wherein on verifying the received navigation signal, the method further comprises determining, by the receiver (101), geo-location of the receiver (101) using the received navigation signal.

8. A receiver (101), the receiver configured for:
pre-processing a received navigation signal; and
verifying if the pre-processed navigation signal is a genuine navigation signal or a spoofed navigation signal by verifying patterns in the pre-processed navigation signal using a trained time series neural network.

9. The receiver, as claimed in claim 8, wherein the receiver is configured for pre-processing the received navigation signal by:
normalizing and standardizing a plurality of features of the received navigation signal, such that values of the plurality of features are in a pre-defined range with minimal deviation; and
configuring the normalized and standardized navigation signal into a plurality of channels.

10. The receiver, as claimed in claim 9, wherein the plurality of features comprise abs_E, abs_L, abs_P, abs_VE, abs_VL, acc_carrier_phase_rad, aux1, aux2, carr_error_filt_hz, carr_error_hz, carrier_doppler_hz, carrier_doppler_rate_hz, carrier_lock_test, CN0_SNV_dB_Hz, code_error_chips, code_error_filt_chips, code_freq_chips, code_freq_rate_chips, CT_LOCK, CT_LOSS, E_I, E_R, L_I, L_R, PRN, PRN_start_sample_count, Prompt_I, Prompt_Q, TG_LOCK, TS_corr, TS_LOCK, TS_LOSS, and TS_TRK.

11. The receiver, as claimed in claim 10, wherein the receiver is configured for verifying patterns in the pre-processed navigation signal by comparing patterns in the plurality of features in the pre-processed navigation signal with patterns in corresponding features of previously recorded navigation signals, wherein the time series based neural network has been trained using the previously recorded navigation signals recorded at a plurality of locations.

12. The method, as claimed in claim 8, wherein the time series neural network is at least one of a Long Short-Term Memory (LSTM); and a Recurrent Neural Network (RNN).

13. The receiver, as claimed in claim 8, wherein on determining that the received navigation signal is spoofed, the receiver is further configured for:
raising an alert; and
ignoring the received navigation signal.

14. The receiver, as claimed in claim 8, wherein on verifying the received navigation signal, the receiver is further configured for determining geo-location of the receiver (101) using the received navigation signal.
